(19) United States
(12) Patent Application Publication
(10) Pub. No.: US 2018/0259676 A1
(43) Pub. Date: Sep. 13, 2018

(54) Litz Wire As Tracer Wire And Litz Wire Marker Tape

(71) Applicant: EAS IP, LLC, Charlottesville, VA (US)

(72) Inventors: Ryan C. Dunn, Charlottesville, VA (US); Robert A. Ross, Charlottesville, VA (US)

(73) Assignee: EAS IP, LLC, Charlottesville, VA (US)

(21) Appl. No.: 15/919,189

(22) Filed: Mar. 12, 2018

Related U.S. Application Data
(63) Continuation-in-part of application No. PCT/US17/50405, filed on Sep. 7, 2017.
(60) Provisional application No. 62/470,185, filed on Mar. 10, 2017.

(51) Int. Cl. G01V 15/00; F16L 1/11

(52) U.S. Cl. CPC G01V 15/00; G01V 3/10; F16L 1/11

(57) ABSTRACT

A new use for Litz wire is described. Litz wire is used as “bare” tracer wire, as tracer wire within known woven polyester or aramid fiber pull tape and as tracer wire within a known marker tape. Litz marker tape is described which is a novel type of marker tape is wherein Litz wire is incorporated into the structure of conventional marker tape so that the marker tape may be remotely located and mapped once it has been buried underground. In addition a method is disclosed for determining the proper size of an individual strand of wire in a Litz wire bundle which is going to be used as Litz pull tape or as Litz marker tape. In addition a method of emplacing Litz wire tracer wire or marker tape using a horizontal boring machine is disclosed.

### GOVERNMENT SUPPORT

None.

### SEQUENCE LISTING

None.

### CROSS-REFERENCE TO RELATED APPLICATIONS

This application claims priority to commonly owned US Provisional application 62/470,185, filed on 10 Mar. 2017, entitled Litz Wire as Tracer Wire and Litz Wire Marker Tape and to commonly owned International Patent Application PCT/US2017/050405, filed on 7 Sep. 2017, entitled Signal Tape.

### FIELD OF THE INVENTION

The present invention relates generally to the field of marker tape and tracer wire for use in location and mapping of underground utilities and specifically to the use of Litz wire as tracer wire and a marker tape using Litz wire as tracer wire. Litz wire may also be incorporated into a fabric tape and used as marker wire in a conventional horizontal boring utility-laying operation. The invention also involves the use of conventional tracer wire embedded within a high strength woven tape product to provide a product called “Tuff Trace” which applicants use as tracer wire in horizontal boring pullback operations. The invention also involves the use of Litz wire embedded within a high strength woven tape product to provide an article which applicants use as tracer wire in horizontal boring pullback operations

### BACKGROUND

### Marker Tape

Marker tape has long been known for use in protecting buried infrastructure from excavation damage. For example, U.S. Pat. No. 3,633,533 issued in 1972 to Gordon H. Allen et al. [hereinafter Allen '533] disclosed an early example of marker tape comprising a thin plastic film which may be made, for example, of polyethylene or polypropylene or polyvinylidene chloride [e.g. Saran™] or a fluorocarbon. As shown in FIG. 1, marker tape 10 may comprise a film 1 which may have a thickness of about 0.001 to 0.002 inch. Each side of film 1 will carry a more or less continuous metallic coating 2, 2′. The metallic coating 2, 2′ may, for example, be made of aluminum which may be deposited as a thin film, of the order of a thickness of 0.00005 to 0.00007 inch by conventional vacuum deposition techniques. On each of the outside surfaces of the metal-coated film 1 there is a protective coating or film 3, 3′ of synthetic plastic which may, again, be of polyethylene or polypropylene or polyvinylidene chloride [e.g. Saran™] or a fluorocarbon.

The finished marker tape 10 should have a color which contrasts with the color of the earth soil surrounding or adjacent to the buried infrastructure. To this end the film 3, 3′ may have a color such as red, green, yellow, or any suitable other color which would contrast to the color of the earth soil in which the buried infrastructure is emplaced. Alternatively, if the film 3, 3′ is transparent, then the color of the metallic coating 2, 2′ itself may serve the purpose of providing to the finished marker tape 10 with a color contrasting to that of the earth soil. Other procedures, which would be known to one of ordinary skill in this art, may also be used to provide the necessary contrasting color to marker tape 10.

Allen '533 also teaches a marker tape 10′ as shown in FIG. 2 comprising two thin metallic layers 4, 4′ each of which may have a thickness in the range of about 0.0005 inch, and which are firmly laminated together by a thin film 5 of a laminating adhesive which may be a catalyzed epoxy cement. A thin film 6, 6′ such as the film 3, 3′ shown in FIG. 1 is laminated to each outside surface of the metallic layers 4, 4′. The provision of a color to the finished marker tape 10′ which color is selected to contrast with the earth soil can be effected in the same manner indicated in connection with the embodiment shown in FIG. 1.

Allen '533 also teaches a marker tape 10″ as shown in FIGS. 3 and 4 comprising a colored polyethylene or other moisture and soil-resistant synthetic plastic tape 7 which has on its surface a metallic wire 8, for example, made of copper, nickel or a ferrous alloy, in the form of a zigzag arrangement. Laminated to the upper surface of tape 7 is another tape 9 of colored polyethylene or synthetic plastic. A variant of this embodiment is initially to coat the metallic wire with a protective synthetic plastic of similar material, as by passing the metallic wire through a hot melt of such plastic or material, and then bond said coated wire directly to the marker tape 10″ by a passage through heated rollers. The purpose of tracer wire 8 is to enable the marker tape 10″ to be detected while buried underground using conventional techniques. The tape is color coded to the type of underground facility and has soil contrasting reflective stripes to aid in tape detention. Allen teaches that the tape will be color coded in the accepted coding for the type of utility line being protected. The uniform color code generally accepted in the industry to identify underground facilities is as follows: Red—electric power lines; Yellow—gas, oil or steam lines; Orange—telephone, police and fire communications and cable television; Blue—water lines; and Green—sewer lines.

The purpose of the metallic foil in marker tapes 10 and 10′ is to permit the marker tape to be detected while buried underground by conventional techniques. The purpose of the metallic wire 8 in marker tape 10″ is also to permit the marker tape to be detected using conventional techniques while buried. In effect, metallic wire 8 is functioning as tracer wire in marker tape 10″.

### Tracer Wire

Tracer wire is well-known for use in aiding the location of underground utilities which are constructed of non-metallic materials. There have been many systems developed over the years to detect, locate and map ferrous and other metallic underground utilities without the use of tracer wire. Most of these systems involve applying or inducing an alternating current in a metallic underground utility. The applied or induced alternating current produces magnetic fields which can then be sensed from the surface and used to map the underground utility. In recent years it has become common practice to use non-metallic or polymer materials for underground utilities. For example, gas, water and sewer lines are increasingly being made of polymers. Location of a non-metallic polymer underground utility by conventional methodology is made possible by burying a metallic “tracer wire” in a known [and constant] spatial relationship to the underground utility. Alternating current is then applied or induced in the tracer wire and the resulting magnetic fields permit the tracer wire to be mapped from the surface. Since the spatial relationship of the tracer wire to the non-metallic underground utility is known—mapping the tracer wire maps the underground utility.

Tracer wire should be buried in a known [and constant] spatial relationship to the underground utility. For example, the tracer wire may be buried a few inches above [or below] the underground utility or a few inches to one side or the other of the underground utility. The important thing is that, whatever the orientation of the tracer wire to the underground utility, that orientation must be constant and known. At predetermined intervals along the length of the underground utility, the tracer wire is brought to the surface of the ground or to a manhole or other access port near the surface of the ground so that an electric current may be applied [from the surface] to the tracer wire. When it is desired to locate the underground utility, the tracer wire is accessed and an AC current is applied to it at one end and another end of the tracer wire is grounded. This AC current flowing through the tracer wire [to the ground] generates a magnetic signal which is broadcast from the tracer wire. This signal can be remotely detected and mapped from the ground surface using hand-held conventional magnetic locating devices [receivers]. For example, the “Maggie” or the “GA-92XTd” magnetic locating receivers from Schonstedt Instrument Company. When the tracer wire's location has been mapped, because the spatial relationship between the location of the tracer wire and the underground utility is known, mapping the tracer wire enables the mapping of the underground utility.

A number of companies sell this type of magnetic locating equipment. For example, the CL 300 Cable Locating Kit from Schonstedt Instrument Company contains a magnetic receiver [such as the “Maggie” or the “GA-92XTd” or a similar receiver] a transmitter to apply an AC current directly to a metallic underground utility, to induce an AC current using an inductive clamp, or by remote induction, and the various accessories necessary to map underground utilities or tracer wire. Using the Schonstedt system, the transmitter can either be electrically connected directly to a metallic underground utility [or to a metallic tracer wire] to induce the desired magnetic fields. In addition, Schonstedt provides an inductive clamp which can be clamped about the underground utility [or the tracer wire] and the transmitter will then induce the desired magnetic fields in the metallic utility or the tracer wire without a direct electrical connection. Lastly, the transmitter has the capability to directly broadcast a varying magnetic field from the surface of the ground, which varying magnetic field will then induce the desired magnetic fields in the buried metallic underground utility or tracer wire. Obviously, this last option is more limited with regard to range and the direct electrical connection is the preferred operating mode. Under ideal conditions, the Schonstedt system can detect underground metallic utilities [or tracer wire] at depths up to nineteen (19) feet.

It is important that the tracer wire be properly treated to protect it from the underground environment. If the tracer wire is mechanically broken during installation or from some unexpected source after installation or if the tracer wire deteriorates and corrosion causes a break in the wire, it will be impossible to use the wire to map an underground utility. As one source¹ relates, the use of improper protective covering for a copper tracer wire can have disastrous results. If the locality specification for tracer wire only requires the contractor to “Install #12 solid copper wire with jacket” as many localities do specify, the contractor may well go to the nearest lumber yard or electrical wholesaler and purchase the cheapest #12 solid copper wire available. Often this will be THHN wire or “Thermoplastic, High-Heat-resistant Nylon-coated wire. The nylon PVC coating on THHN wire will typically last for about two [2] years underground before it deteriorates and exposes the copper. Bare copper wire, over time, tends to return to its original state, that is, earth. This situation will obviously cause a loss of signal and make it much more difficult [or impossible] to use the tracer wire to locate and map an underground utility. “Do's and Don'ts of Tracer Wire Systems”, Michael Moore, downloaded from WaterWorld™ at http://www.waterworld.com/articles/2010/09/dos-and-donts-of-tracer-wire-systems.html in February, 2017.

The tracer wire can be easily laid in the desired location with respect to the underground utility if the utility is installed using a trenching method. The tracer wire can also be laid using a horizontal boring system by affixing the tracer wire to the boring head at the same time as the boring head is used for pulling back the underground utility. This is most often done when the underground utility is made from non-metallic materials and thus not easily locatable after burial by known locating and mapping techniques. In this circumstance, it is known to emplace multiple tracer wires along with the underground utility to ensure that one tracer wire, at least, will not break and thus provide a locating signal when needed. When the utility is laid by boring, the strength of the tracer wire becomes quite important since breakage during pull back is a much greater problem than breakage with a trench-laid underground utility. Since normal copper tracer wire does not have high tensile strength, it is sometimes desired to use copper coated steel wire as tracer wire in boring operations. It is noted that tracer wire can be a solid copper wire but it can also be a copper coated steel-cored wire. This construction gives much increased strength to the tracer wire with substantially the same conductivity for equivalent sized wires.

Conventional prior art tracer wire is shown in FIGS. 5 and 6. Conventional tracer wire 15 comprises a solid copper core 16 covered by insulation 17. FIG. 6 shows the conventional tracer wire as a cross-section along arrow B of FIG. 5.

### Litz Wire

The term “Litz wire” is derived from the German word “litzendraht”, meaning “woven wire.” Generally defined, it is a wire constructed of individually film-insulated wires bunched or braided together in a wire bundle comprising a uniform pattern of twists and length of lay. The multistrand configuration [the wire bundle] minimizes the power losses otherwise encountered in a solid conductor carrying alternating current due to the “skin effect,” or the tendency of radio frequency current to be concentrated at the surface of the conductor. In order to counteract this effect, it is necessary to increase the amount of surface area without appreciably increasing the size of the conductor. This is done by providing a many-stranded bundle of wire with each strand having a small diameter. It is critical that each strand in a Litz wire bundle be insulated—otherwise the entire bundle would simply act as an equivalent sized solid wire. Polyurethane and Polyurethane Nylon films are materials most often used for insulating individual strands because of their low electrical losses and their solderability; however, other insulations can also be used. Litz wires are generally further insulated with a single or double wrap or serving of a textile—typically nylon—on the outside of the wire bundle but they are also available unserved.

Even properly constructed Litz wire will exhibit some skin effect due to the limitations of stranding. Wires intended for higher frequency ranges require more strands of a finer gauge size than Litz wires of equal cross-sectional area but composed of fewer and larger strands. In properly designed Litz wire, the size of the individual strands will be approximately equal to the “skin effect” depth so that power losses due to the skin effect can be minimized.

In a stranded wire construction—such as Litz wire—it is also important to minimize power losses due to the proximity effect. Proximity effect is the tendency for current to flow in loops or concentrated distributions due to the presence of magnetic fields generated by nearby conductors. In transformers and inductors, proximity effect losses are generally more significant than skin effect losses. In Litz wire windings, proximity effect may be sub-divided into internal proximity effect (the effect of other currents within the bundle) and outer proximity effect (the effect of the current in other bundles). The reason for twisting or weaving Litz wire, rather than just grouping fine conductors together without twisting or weaving, is to ensure that the strand currents are equal. Simple twisted bunched conductor wire can accomplish this adequately where proximity effect would be the only significant problem with solid wire. Where skin effect would also be a problem, more complex Litz wire constructions can be used to ensure equal strand currents. Therefore, in a well-designed construction, strand currents are nearly equal. In general, this complex Litz wire construction seeks to have an individual strand running in a given length of a wire bundle to move from the center of the wire bundle to the outside of the wire bundle and then back into the center of the wire bundle, and so forth, in order to eventually occupy every possible position in the cross-section of the wire bundle.

The “skin effect” mentioned above varies with changes in material and frequency. At low frequencies, the skin effect is practically negligible. That is, the “skin depth” or depth of conduction is such that almost the entire cross-section of the conductor is being used for conduction. For example, at a frequency of 60 Hz in copper, the “skin depth” is about a centimeter. As shown in FIG. 7, this would mean that for a copper conductor 15′ which is, for example, 2 centimeters in diameter, carrying alternating current at a frequency of about 60 Hz, almost the entire cross section of the conductor 15′ would be utilized to conduct the current. This is illustrated in FIG. 7 using the stippling clear across the diameter of conductor 15′. At a frequency of 500 Hz in copper, skin depth is approximately 0.34 centimeters. Thus, the 2 centimeter diameter copper wire 15″ shown in FIG. 8 carrying alternating current at 500 HZ would only be using about 60% of the wire cross section to conduct current and the doughnut shaped area stippled in FIG. 8 illustrates the portion of wire 15″ carrying current. At a frequency of 1 MHz in copper, skin depth is approximately 0.0076 cm. This would mean that the 2 centimeter copper wire 16 shown in FIG. 7 carrying alternating current at 1 MHZ would only be using about 1.5% of the wire cross-section to conduct current. This is illustrated by the small doughnut shaped area between the circles in FIG. 9. It is obvious from the forgoing examples that the skin effect can result in considerable conductive losses. To avoid these problems, Litz wire can be used such that, for a given operating frequency, the individual wires in the Litz wire construction are chosen to be about the same thickness as the skin depth, so that there is very little conductive loss due to the skin effect.

Litz wire can be procured in many different configurations. For example, simple Litz wire might comprise five [5] single, film-insulated wire strands, twisted with an optional outer insulation of textile yarn, tape or extruded compound. This construction is illustrated in FIG. 10. Another type of Litz wire might comprise 5 strands of the type of Litz wire shown in FIG. 10 [but without the optional outer insulation] twisted together with an optional outer insulation covering the entire assembly. This type of Litz wire is shown in FIG. 11. Where more strength is desired for the Litz wire assembly, multiple strands of the type of Litz wire shown in FIG. 10 [but without the optional outer insulation] can be twisted around a central fiber core with an outer insulation covering the entire assembly. This is illustrated in FIG. 12. It is also possible to construct the type of Litz wire shown in FIG. 12 with the each individual bundle covered by insulation and then having an outer insulation over the entire assembly. This is illustrated in FIG. 13. If more strength is desired for the Litz wire assembly, insulated bundles of the type of wire shown in FIG. 13 can be twisted around a central fiber core with the entire assembly covered by an outer insulation. This is illustrated in FIG. 14. It is also possible to provide Litz wire as a rectangular cross-section assembly comprised of individual, film insulated wire strands twisted and braided into a rectangular configuration. This is illustrated in FIG. 15. Typical applications for Litz wire conductors include high-frequency inductors and transformers, motors, relays, inverters, power supplies, DC/DC converters, communications equipment, ultra-sonic equipment, sonar equipment, television equipment, and heat induction equipment. The applicants are not aware that anyone has heretofore used Litz wire as tracer wire or in marker tape.

### Horizontal Boring Technology

In a horizontal boring operation a boring bit is pushed into the ground at one location and then pushed generally horizontally through the ground to a remote location where it is then brought back to the surface. The underground utility is attached to the boring bit at the remote location and the bit is then withdrawn back through the bored hole to the first location—thus installing the underground utility. As noted above in § [0014], tracer wire is often pulled back with the utility line so that the non-metallic utility can be located and mapped at a later time.

One of the most common methods currently used to lay underground utilities is horizontal boring using a directional boring machine such as is shown in Geldner, U.S. Pat. No. 5,803,189 [hereinafter “Geldner '189”]. As is discussed in Geldner '189, the conventional directional boring machine comprises a movable carriage mounted on a tracked base with a longitudinal boom mounted on the carriage and a drill head that is mounted on the boom for forward and reverse movement along the longitudinal boom. The boom is angled relative to the surface to be drilled at an angle ranging from 5° to 25°. The drill head includes a rotating spindle, generally driven by a hydraulic motor, to which one or more elongated drill stems are detachably connected. Conventional directional boring machines operate by connecting one end of a first drill stem to the rotating spindle of the drill head and connecting a drill bit to the opposite or outer end. With the drill head in a retracted position on the boom, spindle rotation begins and the drill head is advanced down the boom resulting in the drilling of a bore. When the drill head reaches the outer boom end, the drill stem is detached from the drill head spindle and the drill head is retracted to its original position. One end of a second drill stem is then mounted to the spindle with its opposite end connected to the existing drill stem. The drilling process then continues until the drill head again reaches the end of the boom, and the process is repeated.

The drill stems are relatively rigid, and the bore that is being drilled initially extends in a straight direction at an inclined angle that corresponds to the angle of the boom. The angle of drilling may be altered so that, when a desired depth is reached, the drilling operation is changed to horizontal. When the underground bore is of the desired length, the drill bit can be directed angularly upward until it re-emerges at ground surface or enters a target hole dug at the desired target. The position of the drill bit, both with respect to direction and depth, may be determined by a conventional electronic transmitter located in the drill bit and an electronic receiver that is carried on the ground surface. In this manner, underground bores of considerable length may be bored.

When the drill bit re-emerges from the ground at the target location or enters the target pit, the utility which is being laid is attached to the drill bit, which is specially configured for such attachment, and the drill bit with the utility attached is withdrawn back to the starting point, pulling the utility with it.

FIG. 16 illustrates a conventional horizontal boring operation for laying an underground utility. Directional boring machine 18 is shown setting on ground surface 20. Directional boring machine 18 is taken from Geldner, U.S. Pat. No. 5,803,189 but could be any of the numerous types of directional boring machines on the market. Drill stem 22 extends under the ground surface 20 and defines a borehole. Inspection pit 24 is dug approximately half-way along the intended path of drill stem 22 to permit exact location of drill stem 22 and the associated borehole. Pit 26 is the target pit for the drill stem 22 showing the drill head 28 and a part of drill stem 22 extending into target pit 26.

FIG. 17 illustrates a known end piece or drill head 28 of drill stem 22 [shown in FIG. 16] which carries a conventional generally planar boring head 30 attached thereto and is taken from Melsheimer, U.S. Pat. No. 9,719,344. Adapter 32 is fastened at one end to the face of boring head 30 by a bolt fastening means [not shown in FIG. 17] and at the other end is joined to tow head 34 by swivel joint 36. Tow head 34 carries a duct puller configured to retain and pull a conduit 38 [pipe, cable or the like] during pullback operations. As described supra, directional boring machine 18 is positioned at the desired starting point of the utility and creates a borehole with drill stem 22 and drill head 28 along the desired path of the utility. At the desired end point of the utility, drill head 28 extends into a target hole [or is brought up out of the ground which is not shown in FIG. 16] and the utility 38 is fastened to drill head 28. The drill stem with the utility 38 now attached is withdrawn back through the borehole to the starting point in what is called a pullback operation. It is normal practice when laying a non-metallic utility to tie several marker wires around the swivel joint in order to emplace the marker wires at the same time as the utility is emplaced. The reason several marker wires are used is that the pullback operation often causes one or more of the marker wires to break underground as they are being withdrawn to the starting point. Broken marker wire is pretty much worthless, so multiple wires are tied on in the hope that at least one will make the journey back to the starting point without breakage.

### SUMMARY OF THE INVENTION

Applicants have discovered a new use for Litz wire. Namely that Litz wire can be used as tracer wire for locating and mapping underground utilities which comprise non-metallic material. As noted supra in § [0010], it has become common practice to use non-metallic or polymer materials for underground utilities. For example, gas, water and sewer lines are increasingly being made of polymers. These non-metallic underground utilities can be laid using conventional trenching methods but many are currently being laid using horizontal boring. Applicants have discovered that it is possible to use Litz wire as shown in FIGS. 10-15 as tracer wire by attaching the Litz wire directly to the boring head and laying it with the underground utility in a pullback operation. In this circumstance, strength would be a pre-requisite so it is likely that a stronger type of Litz wire would be used—such as that shown in FIG. 13 or 14.

It is also possible to incorporate Litz wire of the types shown in FIGS. 10-15 within a woven tape similar to the type of tape used in the electrical industry to pull electrical wires through conduits. A standard polyester pull tape might be W/P 1250 Lb Polyester Pull Tape [available in large quantities from The Ribbon Factory at 600 North Brown Street, Titusville, Pa., 16354]. This pull tape is approximately ½ inch wide, approximately 1/16 inch thick and has a tensile strength of 1250 pounds_{f}. Pull tape is available from other sources with different dimensions and widths and in different strengths, for example, up to 2500 pound_{f} tensile strength. Pull tape made from aramid fibers is also available. It is possible to obtain an aramid fiber pull tape with a 3000 pound_{f} tensile strength. This tape is approximately ⅝ inch in width and approximately 1/16 inch thick. It is also possible to obtain polyester pull tape with copper tracer wire incorporated therein. This is illustrated in FIG. 18. Applicants have found that it is possible to incorporate a Litz wire within standard polyester or aramid fiber pull tape and use the Litz wire as conventional tracer wire within the known pull tapes. Pull tape with Litz wire incorporated therein is called “Litz pull tape” by applicants. For example, a Litz pull tape could be buried a few inches above, below, or to one side of a non-metallic underground utility when said utility is laid using a conventional trenching operation. A Litz pull tape could also be laid in a horizontal boring operation by tying the Litz pull tape to the boring head and being pulled back along with the underground utility. This type of installation has the expected advantage of being locatable from the surface using conventional locating and mapping techniques as discussed supra in §§ [0011] and [0012] and it also has the advantage of having the woven tape act as marker tape. When a Litz pull tape constructed of polyester or aramid fibers is struck by an excavator bucket it will be pulled to the surface, thus providing a warning to the excavation crew of a buried underground utility which they may damage if excavation is not halted immediately. One way to increase the effectiveness of this warning is to color the pull tape with brightly colored indicia and to provide written indicia thereon which instructs the excavation crew to cease excavation immediately.

It is also possible to incorporate Litz wire into conventional marker tape to provide a location and mapping capability with marker tape.

### BRIEF DESCRIPTION OF THE DRAWINGS

FIG. 1 shows a first embodiment of a prior art marker tape without tracer wire.

FIG. 2 shows a second embodiment of a prior art marker tape without tracer wire.

FIG. 3 shows a third embodiment of a prior art marker tape which has tracer wire.

FIG. 4 shows a cross section of the marker tape with tracer wire of FIG. 3 along plane A-A of FIG. 3.

FIG. 5 shows a plan view of prior art tracer wire.

FIG. 6 shows a cross-section of the tracer wire of FIG. 5 along arrow B of FIG. 5.

FIG. 7 shows a first cross-sectional view of a conventional wire illustrating the “skin effect”.

FIG. 8 shows a second cross-sectional view of a wire further illustrating the “skin effect”.

FIG. 9 shows a third cross-sectional view of a wire further illustrating the “skin effect”.

FIGS. 10-15 illustrate various known types of Litz wire.

FIG. 16 shows a conventional horizontal boring operation.

FIG. 17 shows a conventional boring head for a horizontal boring machine.

FIG. 18 illustrates a polyester pull tape having tracer wire woven there through.

FIG. 19 shows a graph illustrating the method for picking the optimum wire size in a Litz wire bundle for use with the invention.

FIG. 20 shows a view of an underground utility with conventional tracer wire installed for locating purposes.

FIG. 21 shows a view of the installation of FIG. 20 along the arrow C of FIG. 20.

FIG. 22 shows a view of an underground utility with a pull-tape incorporating Litz wire installed as tracer wire.

FIG. 23 shows a view of the installation of FIG. 22 along the arrow D of FIG. 22.

FIG. 24 shows a plan view of a marker tape according to the invention incorporating Litz wire tracer wire.

FIG. 25 shows a cross-sectional view of the marker tape of FIG. 24 along section E-E of FIG. 24.

FIG. 26 shows an example of Litz Wire incorporated within a woven fabric carrier.

FIG. 27 shows a utility attached to the pulling head of the boring head shown in FIG. 17 and a Litz wire tracer wire attached to the swivel of the boring head shown in FIG. 17.

FIG. 28 shows a another embodiment of the inventive marker tape using various indicia imprinted thereon.

### DETAILED DESCRIPTION

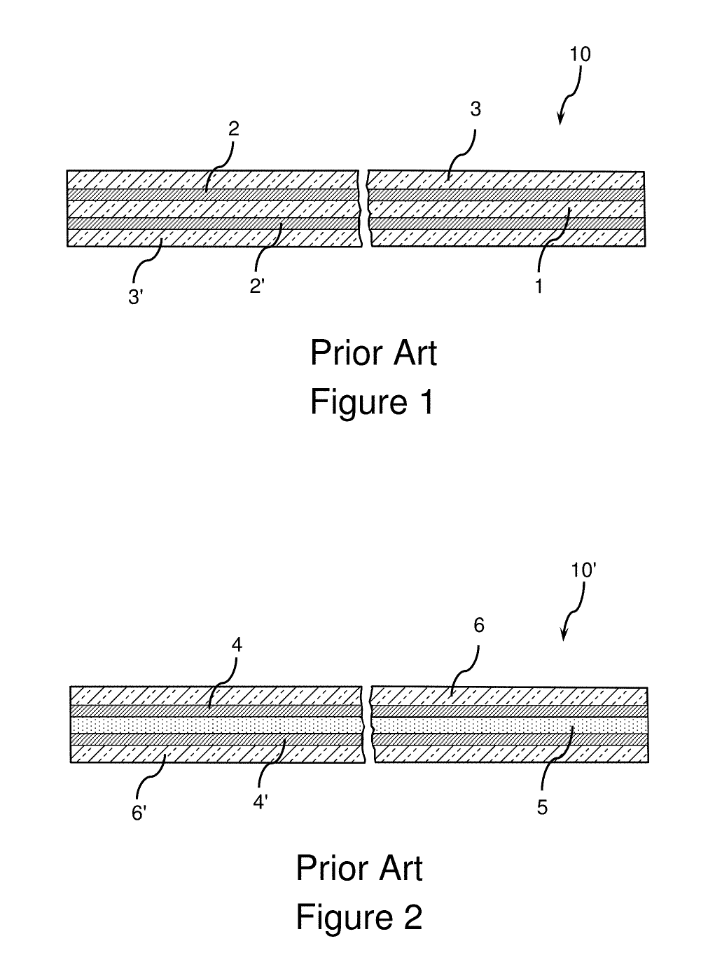

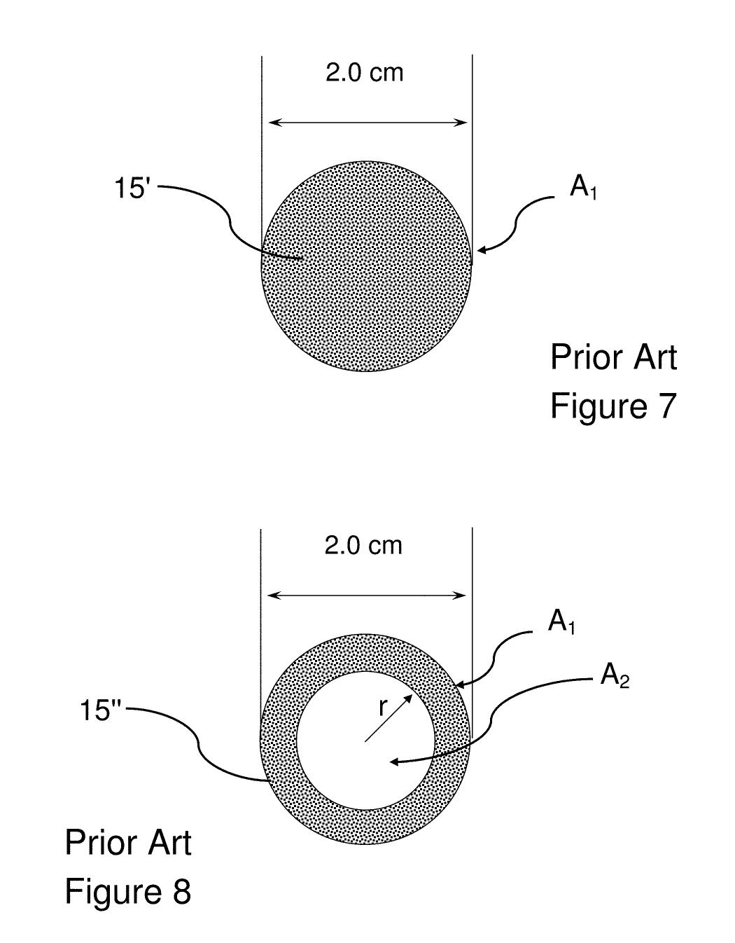

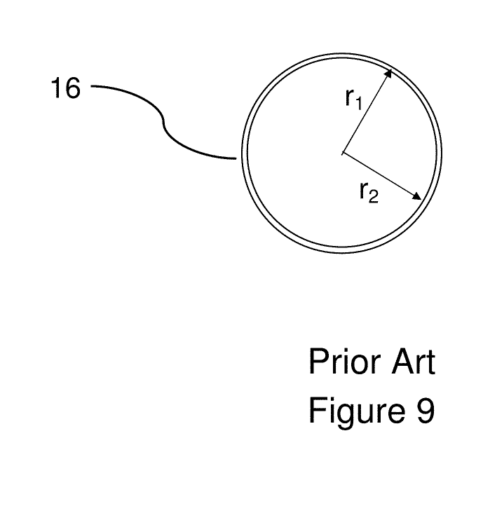

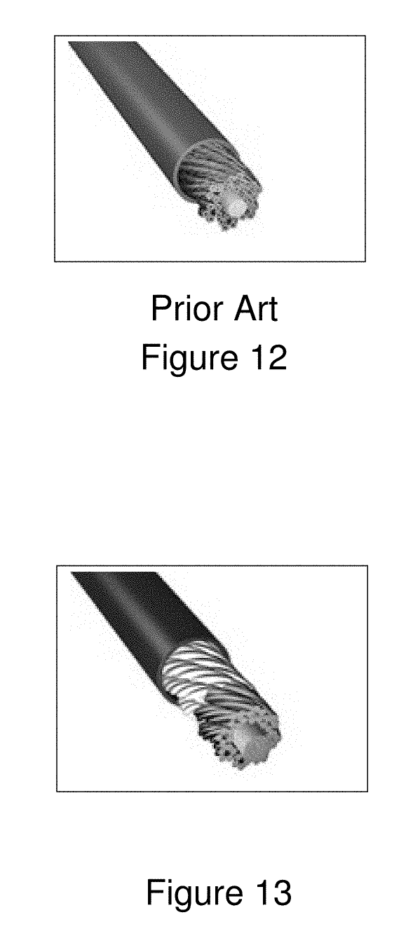

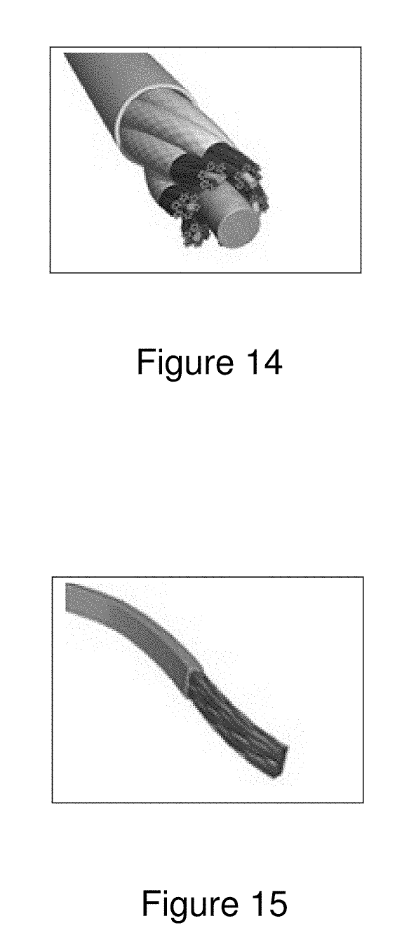

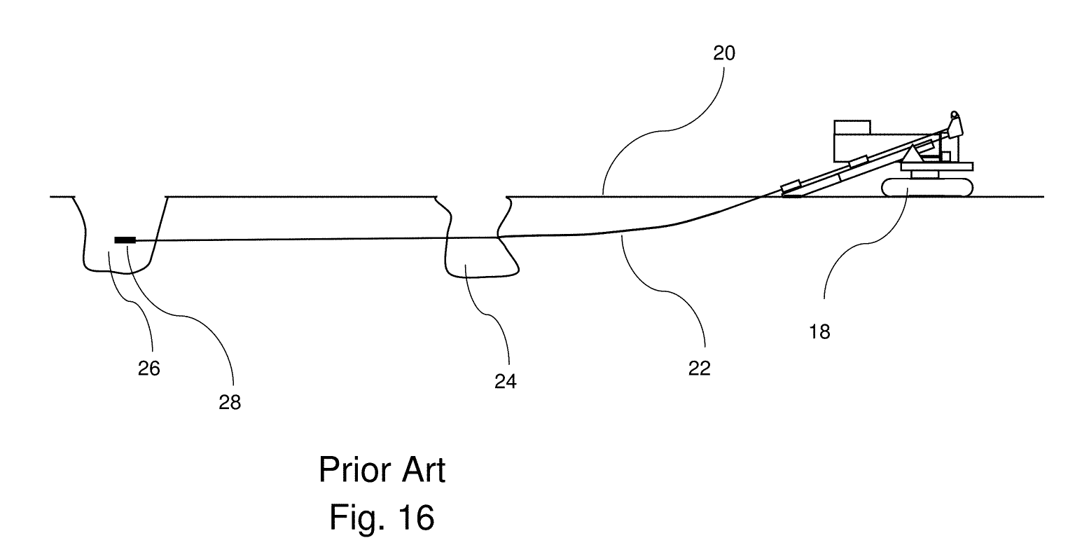

FIGS. 1-18 have been described supra in the BACKGROUND section or the SUMMARY OF THE INVENTION section of this specification—so they will not be further described.

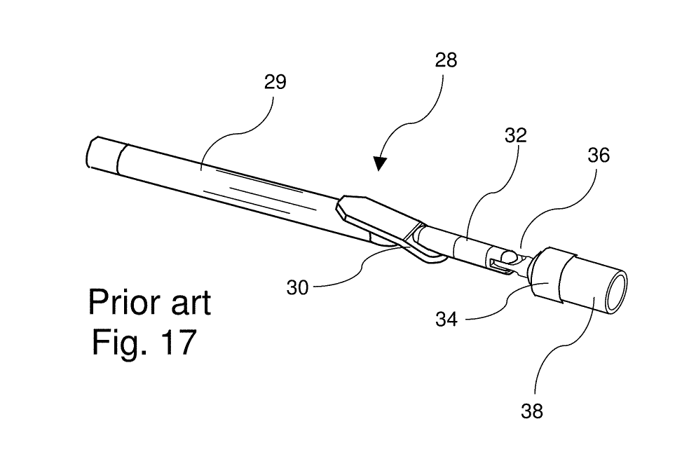

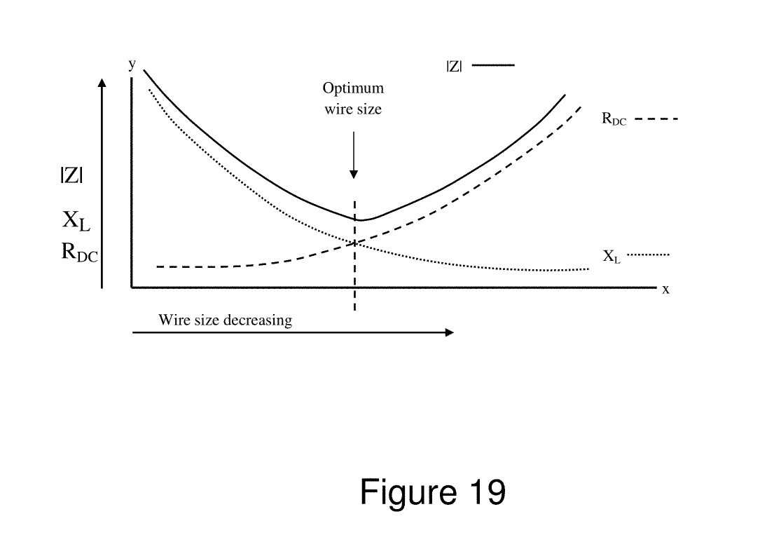

FIG. 19 shows the method of determining optimum wire size in a Litz wire bundle for use with Litz Pull Tape or Litz Marker Tape. The operating frequency of the system which will detect the Litz Pull Tape or Litz Marker Tape is presumed known. The total length of the Litz wire and the number of wires [or strands] in the Litz wire is also presumed known. Thus for a given operating frequency, with a given length of Litz wire and a given number of wires or strands in the bundle, the optimum wire [strand]size is that size which will produce the least value of impedance in the Litz wire. This would mean that any current induced in the Litz wire by a detecting system would be able to produce the strongest magnetic fields for detection. FIG. 19 plots |Z|, X_{L} and R_{DC} for a given length of Litz wire with a given number of wires [strands] in the Litz wire bundle and for a given operating frequency. |Z| is a function of the sum of capacitive reactance [X_{L}] and DC resistance [R_{DC}]. The x axis in FIG. 17 is the wire size of an individual wire in the Litz wire bundle and the size decreases to the right. The y axis is |Z|, X_{L} and R_{DC} increasing upwardly. The absolute value of impedance |Z| is determined by the following equation.

|Z|=X_{L}+R_{DC} [1]

In equation [1] X_{L} is equal to the Inductive reactance which is governed by equation [2].

X_{L}=ωL=2πfL [2]

In equation [2] ω is the frequency or 2πf and L is the inductance of the wire in henries.

$${R}_{DC} = \frac{ρ \times {L}_{length}}{{Area}_{of strand} \times {Number}_{of strands}}$$

[3]

In equation [3] ρ is the DC resistance constant for the type of wire used in the bundle, L is the length of the wire and the remaining variables are self-explanatory. It can be seen that the plot of X_{L} decreases with decreasing wire size and the plot of R_{DC} increases with decreasing wire size. Where the two curves meet, you get the minimum value of |Z| and this is the optimum wire size. This is also shown by the plot of |Z| which is the sum of X_{L} and R_{DC}. Where the plot of |Z| shows the minimum value is where the X_{L} and R_{DC} curves cross. Applicants have found that by using Litz wire as tracer wire instead of solid copper or copper coated steel wire that there is a significant increase in the effective surface area of the Litz wire tracer wire. For example the use of Litz wire as tracer wire can increase the surface area of the wire by about a factor of 4. For example a Litz wire tracer wire that has an equivalent cross-section to a 16 gauge solid copper wire can have about 4 times the wire surface area that the solid wire has. Since induced current is a function of the wire surface area, this will dramatically increase the current induced in the Litz wire tracer wire by known locating and mapping devices. The increase in induced current will result in much greater induced magnetic signal strength when the Litz wire tracer wire is interrogated by conventional locating and mapping transmitters such as those discussed supra in §§ [0010] and [0011]. This, in turn, will make the Litz wire tracer wire much easier to locate.

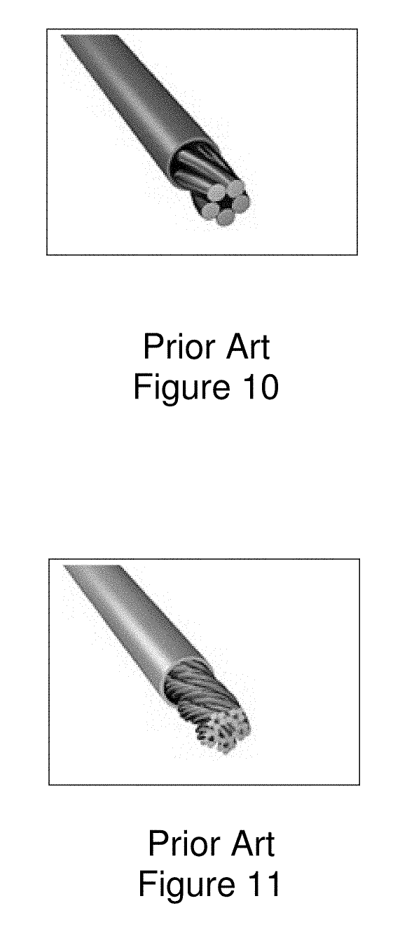

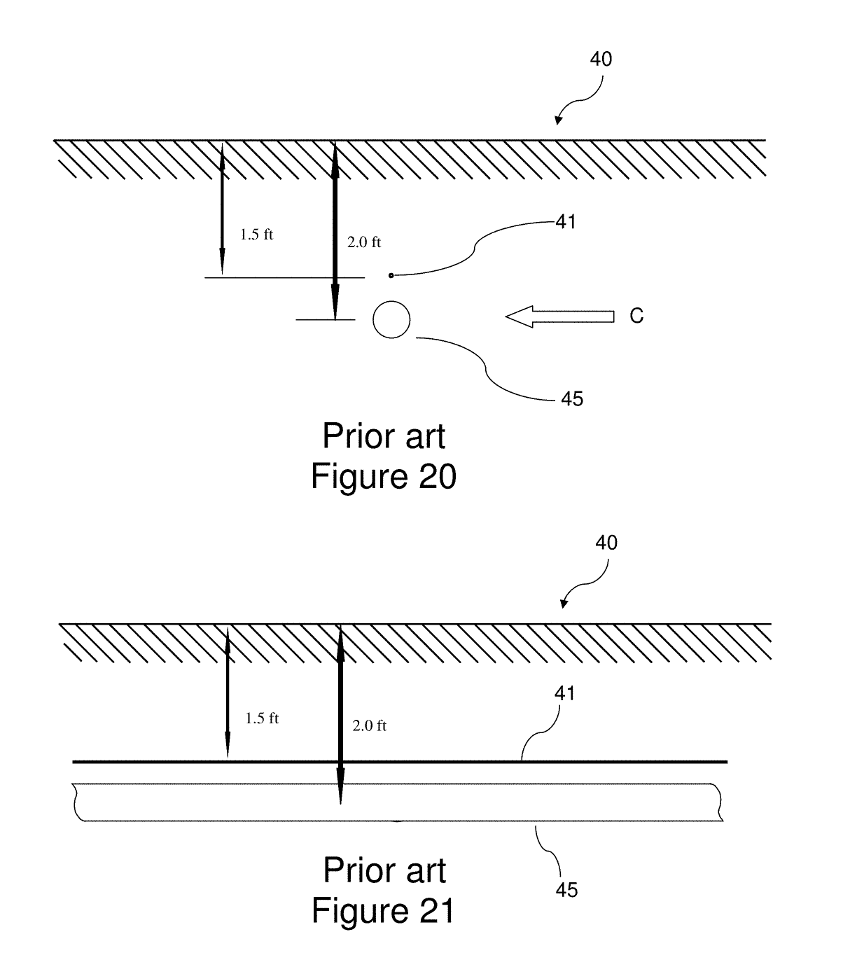

FIG. 20 shows a view of a non-metallic underground utility 45 [in this example, pipe] being buried approximately 2 feet below ground surface 40. Since underground utility 45 is non-metallic, it is thus not detectable from surface 40 by known locating and mapping techniques. To remedy this, a tracer wire 41 is buried approximately 6 inches directly above non-metallic underground utility. This tracer wire is conventional Litz wire chosen from any of the types shown in FIGS. 10-15 or any other known type of Litz wire. The invention is the use of Litz wire as tracer wire in this type of application. FIG. 21 is a view of the installation of FIG. 20 taken along arrow C of FIG. 20.

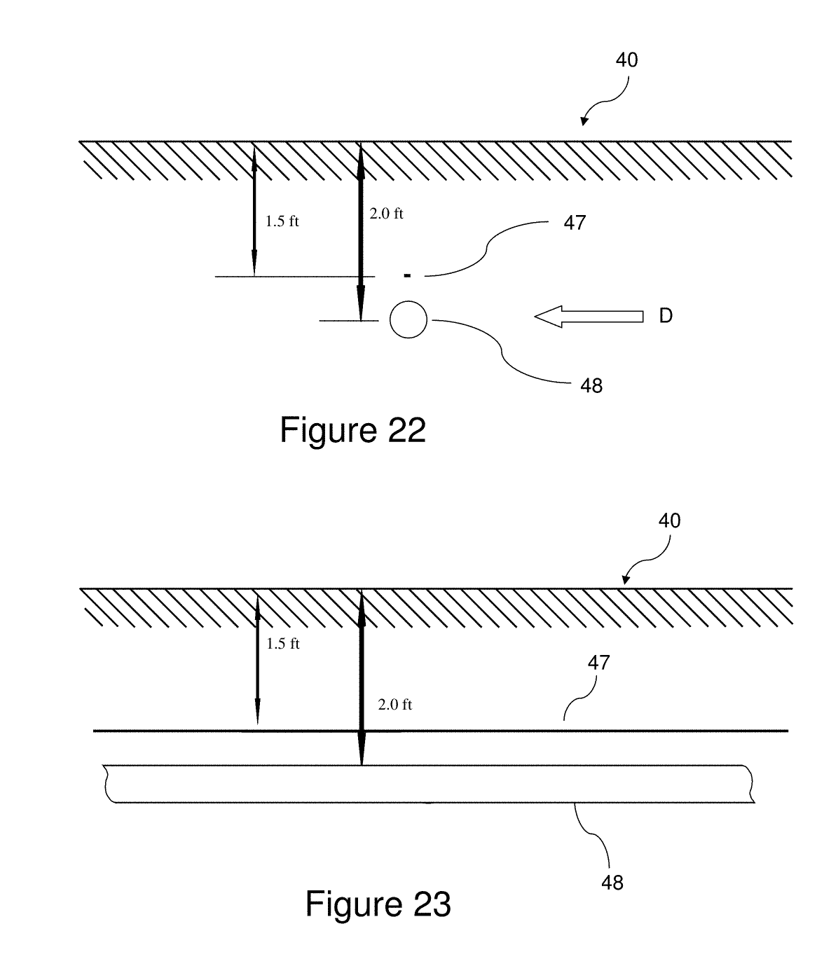

FIG. 22 illustrates a non-metallic underground utility 48 buried approximately 2 feet below the surface 20. To provide a means to locate and map non-metallic underground utility 48 at a later time Litz pull tape 47 is buried approximately 6 inches directly above non-metallic underground utility 48. Litz pull tape 47 comprises, according to the invention, a known polyester pull tape incorporating any type of Litz wire such as those shown in FIGS. 10-15 or any other type of Litz wire. FIG. 23 is a view of the installation of FIG. 22 taken along arrow D of FIG. 22. The advantage of using Litz pull tape is that the non-metallic underground utility may be located and mapped using conventional surface techniques—such as those described above in §§ [0011] and [0012]. However, the use of Litz pull tape also gives advance warning of the presence of the underground utility in a manner similar to marker tape because the polyester pull tape is strong enough to be pulled to the surface by excavation equipment—thus warning the excavation crew of the presence of the underground utility. To make it even more clear to the excavation crew that they are about to dig into an underground utility with possibly disastrous results, the Litz pull tape can be colored or have warning indicia emplaced on the exterior surface thereof in much the same fashion as is disclosed below for applicants marker tape.

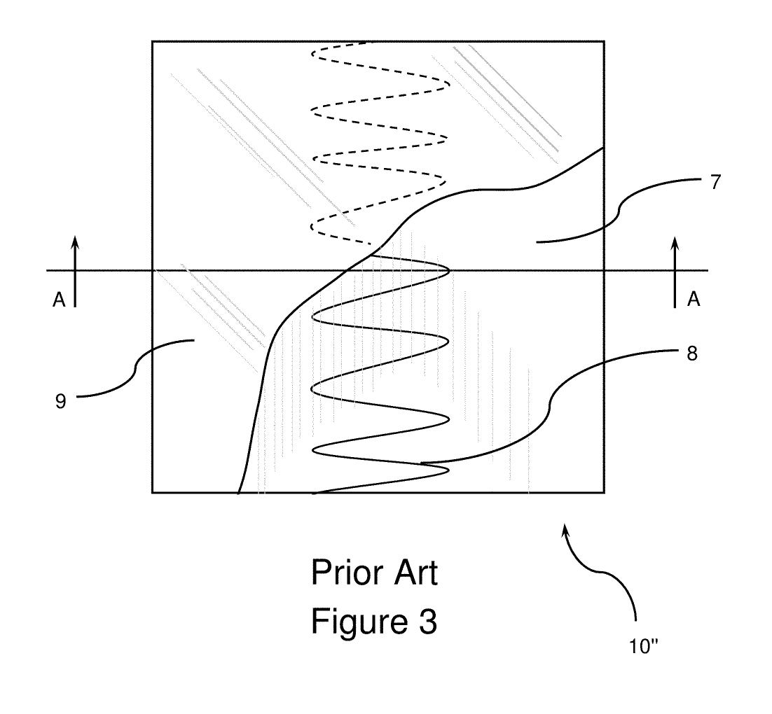

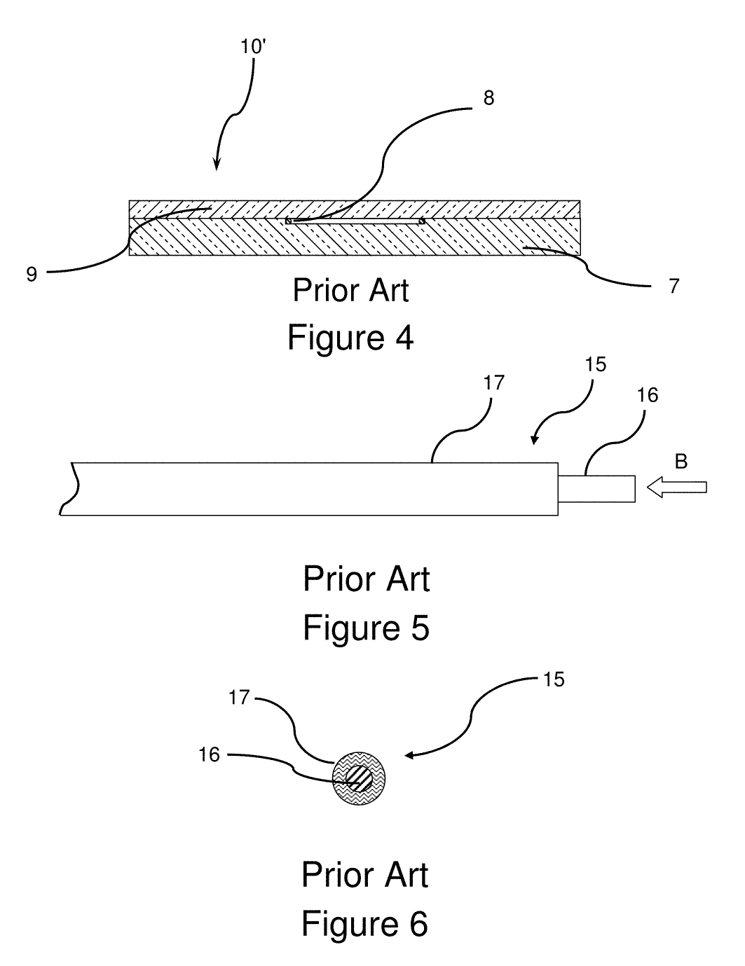

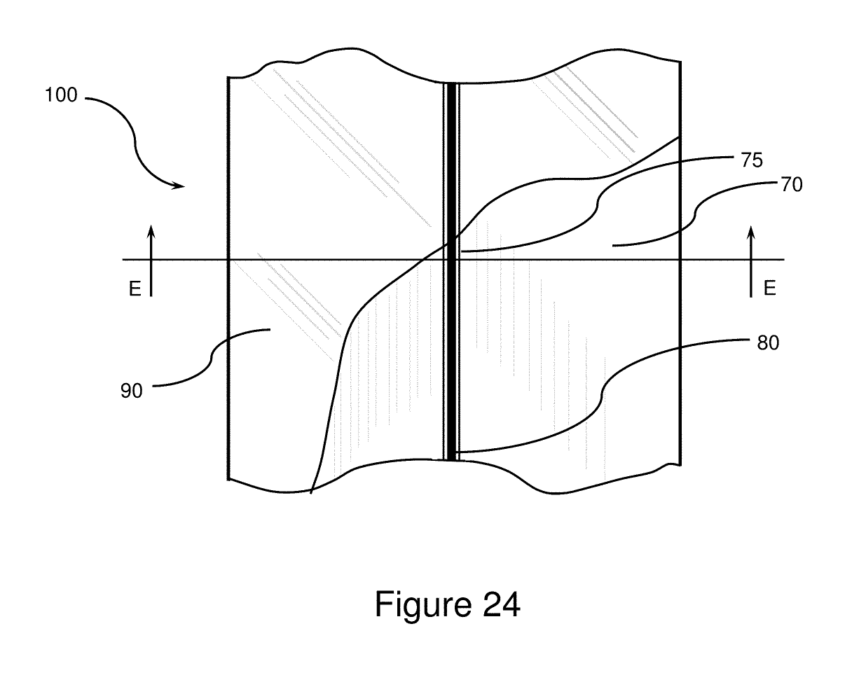

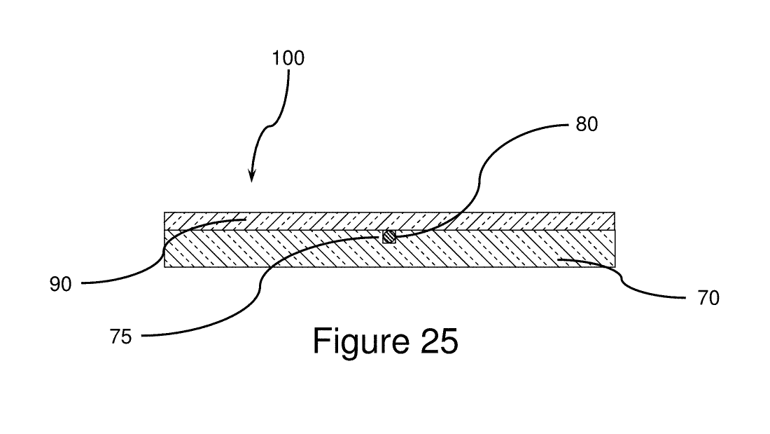

FIG. 24 illustrates a marker tape 100, according to the invention, incorporating Litz wire 80 therein as tracer wire. Applicants call the inventive marker tape Litz marker tape. The marker tape is similar in construction to that of Allen '533 as shown therein in FIGS. 3 and 4. This marker tape is also illustrated in FIGS. 3 and 4 of the instant disclosure and described supra in § [0008]. The inventive marker tape incorporating Litz wire as tracer wire is shown in FIGS. 24 and 25 of applicants' drawings. In the Allen '533 disclosure, tracer wire 8 was embedded within his marker tape in a zigzag fashion. This is not possible when using Litz wire as tracer wire as the Litz wire must be installed in a generally straight line on the marker tape to avoid interference during the detection process. If the Litz wire were installed in a zigzag or sinusoidal manner within marker tape 100, some of the current induced in the tracer wire during detection by conventional location and mapping devices will cancel out the induced current in other sections of the wire—thus it must be straight to function well.

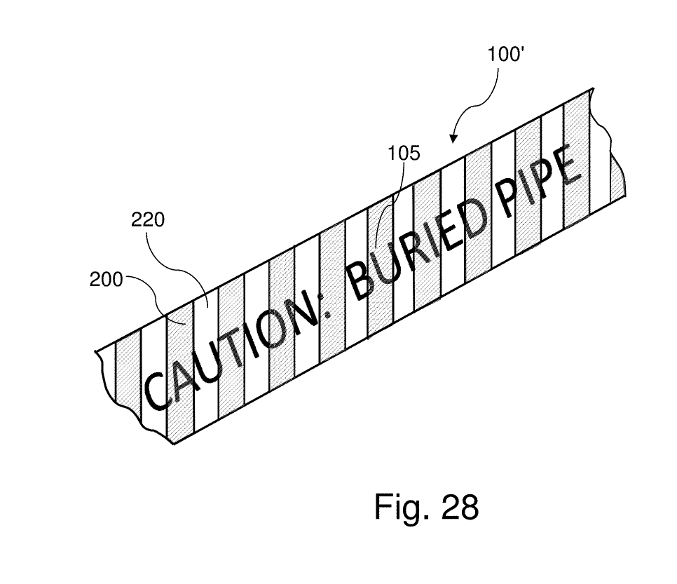

With the foregoing in mind, marker tape 100 as shown in FIGS. 24 and 25 comprises a lower layer 70 of a colored polyethylene or other moisture and soil-resistant synthetic plastic tape having a relatively straight channel 75 formed therein. Litz wire 80 is emplaced within channel 75 to act as tracer wire for marker tape 100. Again, Litz wire 80 could be of any construction for Litz wire. A number of such constructions are shown in FIGS. 10-15, but any type of Litz wire construction could be used. The invention is providing Litz wire within the marker tape as tracer wire. FIG. 25 is a cross-sectional view of marker tape 100 taken along section E-E of FIG. 24. Laminated to the upper surface of lower layer 70 is another layer 90 also made of colored polyethylene or synthetic plastic. Tape 100 may be color coded to the type of underground utility and may have soil contrasting reflective stripes [shown in FIG. 28] to aid in tape detention. Tape 100 will be color coded in the accepted coding for the type of utility line being protected. The uniform color code generally accepted in the industry to identify underground facilities is as follows: Red—electric power lines; Yellow—gas, oil or steam lines; Orange—telephone, police and fire communications and cable television; Blue—water lines; and Green—sewer lines.

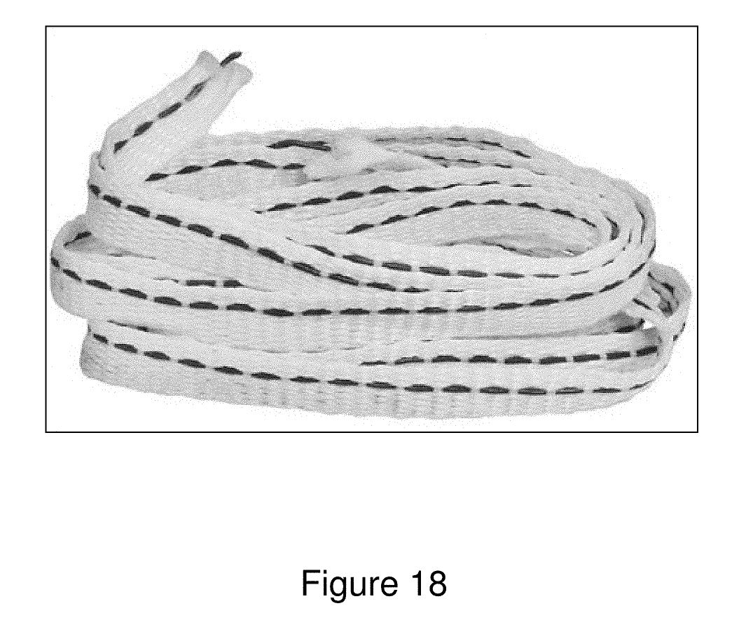

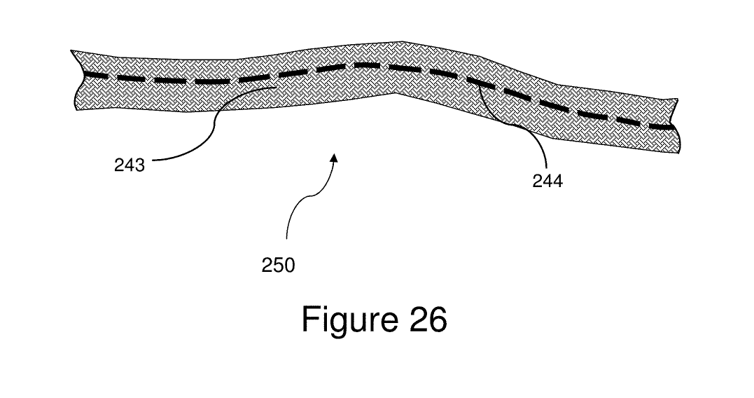

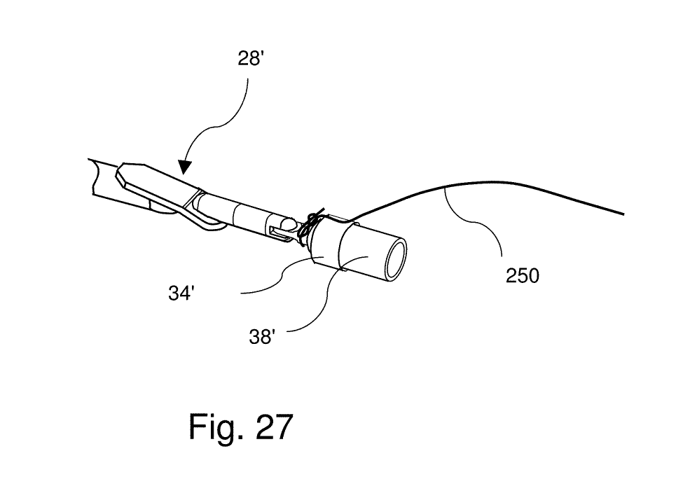

It is also possible to incorporate Litz wire of the types shown in FIGS. 10-15 within a woven tape similar to the type of tape used in the electrical industry to pull electrical wires through conduits. This type of pull tape is shown in FIG. 26. FIG. 26 shows pull tape 250 comprising a woven fabric tape 243 which may comprise polyester fibers with Litz Wire 244 woven and incorporated therein. A standard polyester pull tape might be W/P 1250 Lb Polyester Pull Tape [available in large quantities from The Ribbon Factory at 600 North Brown Street, Titusville, Pa., 16354]. This pull tape is approximately ½ inch [1.27 cm] wide, approximately 1/16 inch [approximately 0.16 cm] thick and has a tensile strength of 1250 pounds_{f} [or approximately 5560 N]. Pull tape is available from other sources with different dimensions and widths and in different strengths, for example, up to 2500 pounds_{f} [approximately 11,000 N] tensile strength. Pull tape made from aramid fibers is also available. It is possible to obtain an aramid fiber pull tape with a 3000 pounds_{f} tensile strength [or approximately 13,3430 N]. This tape is approximately ⅝ inch [approximately 1.59 cm] wide and approximately 1/16 inch [approximately 0.16 cm] thick. It is also possible to obtain polyester pull tape with copper tracer wire incorporated therein. This is illustrated supra in FIG. 18. Applicants have found that it is possible to incorporate Litz wire within standard polyester or aramid fiber pull tape and use the Litz wire as conventional tracer wire within the known pull tapes. Pull tape with Litz wire incorporated therein is called “Litz pull tape” by applicants. For example, a Litz pull tape could be buried a few inches above, below, or to one side of a non-metallic underground utility when said utility is laid using a conventional trenching operation. A Litz pull tape could also be laid in a horizontal boring operation by tying the Litz pull tape to the boring head [as shown infra in FIG. 27] and being pulled back along with the underground utility. This type of installation has the expected advantage of being locatable from the surface using conventional locating and mapping techniques as discussed supra in §§ [0011] and [0012] and it also has the advantage of having the woven tape act in a manner similar to the Signal Tape disclosed in PCT/US2017/050405. That is, when a Litz pull tape constructed of strong polyester or aramid tape is struck by an excavator bucket it will be pulled to the surface in the same manner as the Signal Tape disclosed in PCT/US2017/050405, thus providing a warning to the excavation crew of a buried underground utility which they may damage if excavation is not halted immediately. One way to increase the effectiveness of this warning is to color the pull tape with brightly colored indicia and to provide written indicia thereon which instructs the excavation crew to cease excavation immediately.

FIG. 27 shows the inventive Litz Pull Tape 250 shown in FIG. 26 being tied securely to a horizontal boring machine drill head 28′ similar to drill head 28 shown in FIG. 17. Drill head 28′ is shown ready for a pullback operation with a utility 38′ attached to tow head 34′. In order to prevent damage to the Litz wire embedded within the Litz pull tape 250, the Litz wire is removed from the last few feet of Litz pull tape 250 and this portion of the Litz pull tape, without any Litz wire therein. is tied to tow head 34′, as shown, for pullback so that the pullback forces are transmitted directly to the high strength tape and not to the relatively low strength Litz wire. This part of the operation is called “pullback.” In this manner, utility lines which may be pipes, power lines or telecommunication cables, etc. may be laid without expensive and time-consuming trenching and backfilling.

Marker tape 100′ is illustrated in FIG. 28. It is similar to marker tape 100 but it has various colored indicia thereon to improve visibility. Marker tape 100′ may have cautionary coded indicia 200 in the form of colored stripes extending across tape. If in the illustrated example of FIGS. 20-23, underground utility 45, 48 is assumed to be a water line, then according to the uniform industry code, cautionary stripes 200 would be blue stripes. Marker tape 100′ further includes cautionary contrast stripes 220 extending across the tape and forming a contrast in color with color coded stripes 200 as well as with the color of the surrounding soil. Contrast stripes 220 provide a high visibility and high light reflective characteristic to marker tape 100′ so that the tape can readily be seen when placed in earth soils whose color is close to the color of color coded stripes 200. In addition, written indicia 105 is imprinted on marker tape 100′ either on the outside or as a reverse printing on an inner face of either layer [for example layers 70 or 90 for marker tape 100], as desired. While indicia 200 and 220 make marker tape 100′ easier to see in or out of the soil and provide some information on the type of buried utility present, written indicia 105 provides positive identification of the type of buried utility present and may provide other information, as desired.

The above described embodiments are merely illustrative of the principles of the invention. Those skilled in the art may make various modifications and changes, which will embody the principles of the invention and fall within the spirit and scope thereof.

1. A method for a new use for Litz wire comprising using Litz wire as tracer wire to mark the location of an underground utility.

2. A method for a new use for Litz wire comprising using marker tape with Litz wire incorporated therein to mark the location of an underground utility.

3. A method for a new use for Litz wire comprising using Litz wire incorporated in a conventional fabric pull tape to mark the location of an underground utility.

4. A Litz pull tape comprising a woven polyester tape with a Litz wire tracer wire embedded within said woven polyester tape.

5. A Litz pull tape comprising a woven aramid fiber tape with a Litz wire tracer wire embedded within said woven aramid fiber tape.

6. A marker tape assembly comprising:
a first layer with a first predetermined width and with an indefinite length comprising a colored polyethylene or other moisture or soil resistant synthetic plastic tape with said first layer having an upper and a lower surface;
a substantially straight, open channel with a predetermined cross-section formed on said upper surface of said first layer with said channel running along the length of said first layer;
a Litz wire tracer wire of indefinite length and having a cross-section less than said predetermined cross-section positioned within and running along said channel;
a second layer with a second predetermined width and with an indefinite length comprising a colored polyethylene or other moisture or soil resistant synthetic plastic tape with said second layer also having an upper and a lower surface;
the lower surface of said second layer being laminated to the upper surface of said first layer in order to close said open channel and seal said Litz wire within said marker tape assembly.

7. The marker tape assembly of claim 6 wherein said first predetermined width and said second predetermined width are substantially identical.

8. The marker tape assembly of claim 6 wherein colored warning indicia are imprinted on at least one of the surfaces of said first or second layer.

9. The marker tape assembly of claim 8 wherein said colored warning indicia comprise alternating and contrasting colored stripes running across the predetermined width of at least one of said first or second layers.

10. The marker tape assembly of claim 9 wherein written warning indicia are imprinted on one of said upper or said lower surface of at least one of said layers.

11. A new use for Litz Wire as marker wire comprising burying the Litz Wire near an underground utility so its location can be detected with conventional marker wire locating devices thus enabling determination of the location of the buried utility.

12. A method for a new use for wire woven into and embedded within a woven fabric tape along the longitudinal extent of the woven fabric tape comprising:
drilling an underground borehole with the drill head of a directional drilling machine, attaching the wire woven into and embedded within a fabric tape to the drill head, attaching a utility line to the drill head,
withdrawing the drill head with the utility line and the wire woven into and embedded within a fabric tape attached thereto back along the borehole in a pullback operation, and thus emplacing underground the wire woven into and embedded within a fabric tape at the same time as the utility line is emplaced underground.

13. The method of claim 12 wherein said wire is copper marker wire.

14. The method of claim 12 wherein the woven fabric tape comprises polyester fibers.

15. The method of claim 12 wherein the woven fabric tape comprises aramid fibers.

16. A combination of Litz wire and woven fabric tape for use as marker tape wherein the Litz wire is embedded along the longitudinal extent of the woven fabric tape and woven therein except for a predetermined portion at one end of the woven fabric tape which portion is free of the Litz wire so that said portion may be secured to a drill stem and successfully emplaced as marker wire along with a utility line during a pullback operation.

17. The method of emplacing marker wire and a utility line at the same time in a pullback operation comprising the steps of:
drilling an underground, borehole using a known directional drilling machine comprising a known drilling head, from a fixed starting position on the soil surface to a target site near or on the soil surface but separated from the known starting position by a predetermined distance,
affixing a utility line to the drilling head at the target site in a known manner,
providing a marker tape comprising a woven fabric tape with Litz wire embedded therein along the longitudinal extent of said tape except for a predetermined portion at one end of the woven fabric tape,
affixing said marker tape to the drilling head at the target site by tying said predetermined portion of said marker tape to said drilling head, and
withdrawing said drilling head back through the borehole to the fixed starting position using a pullback step,
whereby the utility line is installed in the borehole and the marker tape is also installed in the borehole at the same time during the pullback step.

18. The method of claim 17 wherein the step of providing a marker tape comprising a woven fabric tape with Litz wire embedded therein along the longitudinal extent of the tape further comprises using a woven fabric tape comprising polyester fibers.

19. The method of claim 17 wherein the step of providing a marker tape comprising a woven fabric tape with Litz wire embedded therein along the longitudinal extent of the tape further comprises using a woven fabric tape comprising aramid fibers.
